(19) United States
(12) Patent Application Publication
(10) Pub. No.: US 2008/0131714 A1
(43) Pub. Date: Jun. 5, 2008

(54) WATER-BASED INTERMEDIATE COATING COMPOSITION AND METHOD FOR FORMING MULTILAYER COATING FILM

(75) Inventors: Teruzo Toi, Kitakatsuragi (JP); Yasuhiko Nakae, Fusimi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Nippon Paint Co., Ltd., Osaka-shi (JP)

(21) Appl. No.: 12/024,370

(22) Filed: Feb. 1, 2008

Related U.S. Application Data
(62) Division of application No. 10/743,128, filed on Dec. 23, 2003.

(30) Foreign Application Priority Data
Dec. 27, 2002 (JP) 2002-379311

(51) Int. Cl. B32B 27/28; B05D 3/02

(52) U.S. Cl. 428/475.2; 427/387; 428/480

(57) ABSTRACT

The present invention provides a water-based intermediate coating composition having excellent chipping resistance and water resistance when made into a multilayer coating film, and providing excellent adaptability with a top coating film and a base coating film and excellent finish appearance, and a method for forming a multilayer coating film using the same. A water-based intermediate coating composition comprising a copolymer resin emulsion and a curing agent, the copolymer resin emulsion being obtained by emulsion polymerizing: a monomer (a) comprising at least one monomer selected from (meth)acrylic acid alkyl esters, and further comprising, as is necessary, at least one monomer selected from the group consisting of styrene-based monomers, (meth)acrylonitrile, and (meth)acrylamide; an acid group-containing polymerizable unsaturated monomer (b); a hydroxyl group-containing polymerizable unsaturated monomer (c); and a cross-linkable monomer (d), wherein a glass transition temperature of said resin is in the range of −50° C. to 20° C., an acid value of said resin is in the range of 2 to 60 mg KOH/g, and a hydroxyl value of said resin is in the range of 10 to 120 mg KOH/g.

### BACKGROUND OF THE INVENTION

1. Field of the Invention

The present invention relates to a water-based intermediate coating composition and a method for forming a multilayer coating film.

2. Disclosure of the Related Art

In recent years, from the view points of global environmental issues and ecology, environment-adaptable water-based coating materials in which organic solvents used in the coating material are partially or completely replaced with water have been widely used in the fields of an industrial coating material such as automobile coating material, or construction and building coating material. However, coating films formed of such conventional water-based coating materials were inferior in mechanical properties, solvent resistance, and water resistance.

When such conventional water-based coating materials are used in such as automobile coating materials, in particular, in intermediate coating materials, more specifically, in intermediate coating materials of three-wet system (wet-on-wet coating, namely, a coating system whereby a plurality of heat-curable water-based coating materials are sequentially applied one after another without curing) which is especially requested in recent years for saving energy, problems arose especially in a coating film such that chipping resistance of the coating material is poor, peeling occurs at the boundary with an electrodeposition coating film serving as a base coating or at the boundary with a base coat serving as a top coating, stability of the coating film is not appropriate due to poor solvent resistance, and water resistance and durability of the coating film are poor. For this reason, alternation to water-based coating materials from organic solvent-based coating materials has not proceeded.

Now explanation about intermediate coating materials used in the three-wet system will be given. In automobile body coating, a multilayer coating film is formed. Specifically, this multilayer coating film is formed in the following steps: first forming an electrodeposition coating film by cationic electrodeposition on a sheet steel which has been treated with zinc phosphate; applying an intermediate coating material on the electrodeposition coating film to form an intermediate coating film; then applying a base coating material for ornamentalization on the intermediate coating film to form a base-coat coating film; and finally applying a clear coating material on the base-coat coating film to form a clear top coating film. In this process of forming a multilayer coating film, conventionally, a baking-curing process is executed both after formation of the intermediate coating film and after formation of the clear top coating film. In the three-coat-one-bake coating technique, the baking-curing process executed after formation of the intermediate coating film is omitted, and hence the baking-curing process which is conventionally executed twice is executed just once. By omitting the baking-curing process after formation of the intermediate coating film, it is possible to save vast amounts of energy and to reduce the time required for coating process, so that cost-down advantage is achieved. On the other hand, the intermediate coating material is required to have more efficient curing mechanism so as not to cause deterioration in physical properties of the intermediate coating film. However, conventional water-based intermediate coating composition has not responded to such requisition.

For example, Japanese published unexamined application No. Hei. 8-33865 relates to a wet-on-wet coating technique comprising the steps of coating with a heat-curable water-based coating material (A) and coating the coated surface not having subjected to curing with a heat-curable water-based coating material (B). This published application discloses that neutralization value of a base resin in the water-based coating material (A) is in the range of 10 to 40 mg KOH/g, and neutralization value of a base resin in the water-based coating material (B) is selected to be larger than that of the water-based coating material (A) by the range of 10 to 20 mg KOH/g; the water-based coating material (A) contains a base resin having a carboxyl group and a cross-linkable group, and a cross-linking agent; and acid value of the base resin of the water-based coating material (A) is in the range of 10 to 50 mg KOH/g. However, these coating materials were not satisfactory in respect of having both self-crosslinkability and reaction curability.

For example, Japanese published unexamined application No. 2001-205175 relates to a method for forming a coating film wherein on an object to be coated having an electrodeposition film formed thereon, an intermediate coating film, a metallic base coating film, and a clear coating film are sequentially formed by using a water-based intermediate coating material, a water-based metallic base coating material, and a clear coating material, respectively. This published application also discloses that the water-based intermediate coating material contains dispersion of amide-group containing acrylic resin particles dispersed in water which are obtained by emulsion polymerizing an amide group-containing ethylenic unsaturated monomer and other ethylenic unsaturated monomer, and that acid value of the amide group-containing acrylic resin particles is in the range of 0 to 100 mg KOH/g. As the other ethylenic unsaturated monomer, carboxyl group-containing monomers, hydroxyl group-containing monomers and (meth)acrylate monomers are disclosed, and as the cross-linkable monomer, polymerizable unsaturated monocarboxylic acid esters of polyhydric alcohols are disclosed. However, this water-based intermediate coating material was also insufficient in respect of having both self-crosslinkability and reaction curability, and appearance of a multilayer coating film obtained from this coating material was not satisfactory.

Under such a circumstance, there is a special need for a water-based intermediate coating composition having excellent mechanical characteristics such as viscoelasticity behavior, strong solvent resistance and water resistance, achieving good adhesivity with a top coating film and a base coating film after coated, and providing a coating film of excellent finish appearance.

### SUMMARY OF THE INVENTION

Therefore, it is an object of the invention to solve the above problems associated with the conventional arts, and to provide a water-based intermediate coating composition having excellent chipping resistance and water resistance when made into a multilayer coating film, and providing excellent adaptability with a top coating film and a base coating film and excellent finish appearance, and a method for forming a multilayer coating film using the same.

As a result of enthusiastic efforts, the inventors of the present invention found that by introducing self-crosslinkability to a resin by emulsion polymerizing a mixture of an acrylic monomer, an acid group-containing monomer, a hydroxyl group-containing monomer, and a cross-linkable monomer, selecting glass transition temperature (Tg), acid value and hydroxyl value of the obtainable resin in specific ranges, and adding a curing agent at the time of producing a coating material so as to improve curing reactivity with the resin, it is possible to obtain a coating composition which can provide a multilayer coating film having excellent chipping resistance and water resistance and realizing satisfactory finish appearance, and accomplished the present invention.

The present invention includes the following:

<1> A water-based intermediate coating composition comprising a copolymer resin emulsion and a curing agent,

the copolymer resin emulsion being emulsion-polymerized from:

a monomer (a) comprising at least one monomer selected from (meth)acrylic acid alkyl esters, and further comprising, as is necessary, at least one monomer selected from the group consisting of styrene-based monomers, (meth)acrylonitrile, and (meth)acrylamide;

an acid group-containing polymerizable unsaturated monomer (b);

a hydroxyl group-containing polymerizable unsaturated monomer (c); and

a cross-linkable monomer (d), wherein a glass transition temperature of the resin is in the range of −50° C. to 20° C., an acid value of the resin is in the range of 2 to 60 mg KOH/g, and a hydroxyl value of the resin is in the range of 10 to 120 mg KOH/g.

<2> The water-based intermediate coating composition of above <1>, wherein the cross-linkable monomer (d) comprises at least one cross-linkable monomer selected from the group consisting of carbonyl group-containing polymerizable unsaturated monomers, hydrolyzable polymerizable silyl group-containing monomers, and polyfunctional vinyl monomers.

<3> the water-based intermediate coating composition of above <1> or <2>, comprising at least said carbonyl group-containing polymerizable unsaturated monomers as said cross-linkable monomer (d) and a hydrazine compound as a cross-linking auxiliary agent. Namely, in the present invention, when carbonyl group-containing monomers are used, it is preferred to add a hydrazine compound as a cross-linking auxiliary agent in the above water-based coating composition to allow formation of a cross-link structure when a coating film is formed.

<4> The water-based intermediate coating composition of any of above <1> to <3>, wherein the curing agent comprises at least one curing agent selected from the group consisting of melamine resins, isocyanate resins, oxazoline-based compounds, and carbodiimide-based compounds.

<5> The water-based intermediate coating composition of any of above <1> to <4>, wherein the cross-linkable monomer (d) is used in an amount of 0.5 to 10% by weight, relative to the total amount of the monomers (a), (b), and (c).

<6> The water-based intermediate coating composition of any of above <1> to <5>, wherein the curing agent is contained in an amount of 2% to 50% by weight, relative to the total amount of solid content of the curing agent and the copolymer resin emulsion.

<7> The water-based intermediate coating composition of any of above <1> to <6>, further comprising a pigment-dispersed paste containing a pigment and a pigment dispersant.

<8> The water-based intermediate coating composition of above <7>, wherein

the pigment is contained in an amount of 10 to 60% by weight, relative to the total amount of solid content of all resins contained in the water-based intermediate coating composition and the pigment, and

the pigment dispersant is contained in an amount of 0.5 to 10% by weight, relative to the amount of the pigment.

<9> The water-based intermediate coating composition of above <7> or <B>, wherein the pigment dispersant contains no or not more than 3% by weight of volatile basic substances, relative to the solid content of the pigment dispersant.

In the present invention, glass transition temperature (Tg) of copolymer resin is a theoretical value which can be calculated by suitable approximation from glass transition temperatures Tgi (i=1, 2, . . . , i) of respective homopolymers of monomers Mi (i=1, 2, . . . , i) used in the polymerization and respective weight fractions Xi (i=1, 2, . . . , i) of the monomers Mi (i=1, 2, . . . , i) in accordance with the following relational expression:

1/Tg=Σ(Xi/Tgi) (1)

In the present invention, acid value and hydroxyl value of a copolymer resin are values which are calculated from blending amounts of monomers used for the polymerization.

<10> A method for forming a multilayer coating film, comprising the steps of: (1) applying an electrodeposition coating material on an object to be coated to form an electrodeposition coating film; (2) applying a water-based intermediate coating composition on the electrodeposition coating film to form an intermediate coating film; and (3) applying a top coating material on the intermediate coating film without curing the intermediate coating material, to form a top coating film, wherein the water-based intermediate coating composition is the water-based intermediate coating composition of any of above <1> to <9>.

<11> The method for forming a multilayer coating film of above <10>, wherein the intermediate coating film and the top coating film is cured simultaneously after the step (3).

<12> The method for forming a multilayer coating film of above <10> of <11>, wherein the object to be coated is automobile body.

<13> A multilayer coating film obtained by the method for forming a multilayer coating film of any of above <10> to <12>.

The present invention can provide a water-based intermediate coating composition having desirable performance such as excellent chipping resistance and water resistance, as well as excellent adaptability with a top coating film and base coating film and excellent finish appearance, when it is made into a multilayer coating film, and a method for forming a multilayer coating film using the same.

In the method for forming a multilayer coating film, in particular, by using a water-based coating material containing less amount of remaining basic substance, it is possible to form a coating film having the desirable performance as described above while preventing the coating film from yellowing even in a three-coat-one-bake coating system.

Therefore, the method for forming a multilayer coating film according to the present invention can be suitably used in a three-wet coating system which aims at reducing the coating process, reducing the cost and reducing the environmental load, especially for coating the body of such as automobiles.

### DETAILED DESCRIPTION OF THE INVENTION

The present invention will now be explained in detail. A water-based intermediate coating composition of the present invention includes a copolymer resin emulsion and a curing agent. First, individual monomer components (a), (b), (c), and (d) of the copolymer resin emulsion will be explained. In this specification, “acrylic” polymerizable unsaturated monomers and “methacrylic” polymerizable unsaturated monomers are generically denoted by “(meth)acrylic” monomers.

The monomer component (a) is a polymerizable unsaturated monomer containing neither acid groups nor hydroxyl groups, and essentially containing (meth)acrylic acid alkyl ester.

As the (meth)acrylic acid alkyl ester, those having an alkyl group of 1 to 18 carbon atoms are preferred, and concrete examples of such esters include methyl(meth)acrylate, ethyl(meth)acrylate, propyl(meth)acrylate, n-butyl(meth)acrylate, isobutyl(meth)acrylate, t-butyl(meth)acrylate, hexyl(meth)acrylate, 2-ethylhexyl(meth)acrylate, octyl(meth)acrylate, nonyl(meth)acrylate, decyl(meth)acrylate, dodecyl(meth)acrylate, stearyl(meth)acrylate and the like. These may be used alone or two or more of these may be used in combination.

The monomer component (a) may optionally contain at least one monomer selected from the group consisting of styrenic monomers, (meth)acrylonitrile, and (meth)acrylamide. Examples of the styrenic monomers may include α-methylstyrene and the like beside styrene. These may be used alone or two or more of these may be used optionally in combination.

The acid group-containing polymerizable unsaturated monomer (b) is an ethylenic unsaturated compound having at least one acid group in its molecule, and the acid group is selected from, for example, a carboxyl group, sulfonic acid group, phosphoric acid group and the like.

An example of the carboxyl group-containing polymerizable unsaturated monomer of the acid group-containing polymerizable unsaturated monomers (b) may include, for example, acrylic acid, methacrylic acid, crotonic acid, isocrotonic acid, ethacrylic acid, propylacrylic acid, isopropylacrylic acid, itaconic acid, maleic anhydride, fumaric acid. The sulfonic acid group-containing polymerizable unsaturated monomers may include, for example, p-vinylbenzenesulfonic acid, p-acrylamidepropane sulfonic acid, t-butylacrylamidesulfonic acid. The phosphoric acid group-containing polymerizable unsaturated monomers may include, for example, Light Ester PM (manufactured by KYOEISHA CHEMICAL Co., LTD.) such as monophosphate of 2-hydroxyethylacrylate, monophosphate of 2-hydroxypropylmethacrylate. These may be used alone or two or more of these may be used optionally in combination.

The acid group-containing polymerizable unsaturated monomer (b) improves various stabilities such as storage stability, mechanical stability and stability against freezing of the resultant resin emulsion, and acts as a catalyst which promotes curing reaction with a curing agent such as melamine resin at the time of forming a coating film. In the monomer (b), it is important to use a carboxylic acid-group containing monomer from the view points of improvement of aforementioned stabilities and ability of catalytic promotion of the curing reaction. Preferably, the monomer (b) contains not less than 50% by weight of carboxylic acid group-containing monomers.

An example of the hydroxyl group-containing polymerizable unsaturated monomer (c) may include, for example, 2-hydroxyethyl(meth)acrylate, 2-hydroxypropyl(meth)acrylate, 4-hydroxybutyl(meth)acrylate, N-methylol acrylamide, allyl alcohol, ε-caprolactone-modified acrylic monomer. These may be used alone or two or more of these may be used optionally in combination.

An example of the ε-caprolactone-modified acrylic monomer may include “PLACCEL FA-1”, “PLACCEL FA-2”, “PLACCEL FA-3”, “PLACCEL FA-4”, “PLACCEL FA-5”, “PLACCEL FM-1” “PLACCEL FM-2” “PLACCEL FM-3” “PLACCEL FM-4” “PLACCEL FM-5” (manufactured by Daicel Chemical Industries Ltd.)

The hydroxyl group-containing polymerizable unsaturated monomer (c) affords hydrophilicity based on the hydroxyl group to the resin by copolymerization, thereby improving operability and stability against freezing when the resultant resin emulsion is used as a coating material, while affording curing reactivity with a melamine resin or an isocyanate-type curing agent.

For the cross-linkable monomer (d), a cross-linkable monomer such as a carbonyl group-containing polymerizable unsaturated monomer, hydrolyzable polymerizable silyl group-containing monomer, any of various polyfunctional vinyl monomers and the like may be used.

An Example of the carbonyl group-containing monomer may include a keto group-containing monomer such as acrolein, diacetone (meth)acrylamide, acetoacetoxyethyl(meth)acrylate, formylstyrol, an alkylvinyl ketone having 4 to 7 carbon atoms (for example, methylvinyl ketone, ethylvinyl ketone, butylvinyl ketone) and the like. Among those listed above, diacetone (meth)acrylamide is preferred. When using such a carbonyl group-containing monomer, a hydrazine-type compound as a cross-linking auxiliary agent is added to copolymer resin emulsion to form the cross-linking structure upon forming a coating film.

An examples of the hydrazine-type compound may include a saturated aliphatic carboxylic acid dihydrazide having 2 to 18 carbon atoms such as oxalic acid dihydrazide, malonic acid dihydrazide, glutaric acid dihydrazide, succinic acid dihydrazide, adipic acid dihydrazide and sebacic acid dihydrazide; a monoolefinic unsaturated dicarboxylic acid dihydrazide such as maleic acid dihydrazide, fumaric acid dihydrazide and itaconic acid dihydrazide; phthalic acid dihydrazide, terephthalic acid dihydrazide, isophthalic acid dihydrazide and dihydrazide, trihydrazide or tetrahydrazide of pyromellitic acid: nitrilotrihydrazide, citric acid trihydrazide, 1,2,4-benzene trihydrazide, ethylenediamine tetraacetic acid tetrahydrazide, 1,4,5,8-naphthoic acid tetrahydrazide and a polyhydrazide obtained by reacting an oligomer having a lower alkyl carboxylate group with hydrazine or hydrazine hydrate; carboxyl dihydrazide and bissemicarbazide; an aqueous polyfunctional semicarbazide obtained by reacting a diisocyanate such as hexamethylene diisocyanate and isophorone diisocyanate or a polyisocyanate compound derived therefrom with an excess of a hydrazine compound or dihydrazide listed above and the like.

An example of the hydrolyzable polymerizable silyl group-containing monomer may include an alkoxysilyl group-containing monomer such as γ-(meth)acryloxypropylmethyldimethoxysilane, γ-(meth)acryloxypropylmethyldiethoxysilane, γ-(meth)acryloxypropyltriethoxysilane and the like.

The polyfunctional vinyl monomer is a compound having two or more radical polymerizable ethylenic unsaturated groups in its molecule.

Examples of the polyfunctional vinyl monomer may include a divinyl compound such as divinylbenzene, ethylene glycol di(meth)acrylate, hexanediol di(meth)acrylate, polyethylene glycol di(meth)acrylate, allyl(meth)acrylate, 1,4-butanediol di(meth)acrylate, 1,6-hexane di(meth)acrylate, neopentyl glycol di(meth)acrylate and pentaerythritol di(meth)acrylate, and also include pentaerythritol tri(meth)acrylate, trimethyrol propane tri(meth)acrylate, dipentaerythritol hexa(meth)acrylate and the like.

As the cross-linkable monomer (d) these may be used alone or two or more of these may be used in combination. As a result of copolymerization of the monomer (d), self-crosslinkability is given to the resultant copolymer resin emulsion.

The copolymer resin emulsion according to the present invention may be obtained by selecting the kinds and blending amounts of the monomer components (a), (b), (c), and (d) so that the copolymer resin obtainable from the respective monomer components has a glass transition temperature in the range of −50° C. to 20° C., an acid value in the range of 2 to 60 mg KOH/g and a hydroxyl value in the range of 10 to 120 mg KOH/g, and copolymerizing these selected monomer components by emulsion copolymerization.

Glass transition temperature (Tg) of the copolymer resin falls within the range of −50° C. to 20° C. By setting Tg within this range, when a water-based intermediate coating material containing the copolymer resin emulsion is used in a wet-on-wet system, affinity and adhesion with a base and top coating materials are improved, and adaptability with both of the base and top coating materials in wet condition at boundaries therebetween is improved, so that inversion will not occur. In addition, a coating film finally obtained has appropriate flexibility and improved chipping resistance. Consequently, it is possible to form a multilayer coating film having very good appearance. If Tg of the resin is lower than −50° C., mechanical strength of the coating film is insufficient so that the chipping resistance is weak. On the other hand, if Tg of the resin is higher than 20° C., the coating film becomes hard and brittle, so that it is inferior in impact resistance and chipping resistance. Therefore, Tg of the resin is in the range of −50° C. to 20° C., preferably in the range of −40° C. to 10° C., more preferably in the range of −30° C. to 0° C. The kinds and blending amounts of the above monomer components are selected so that Tg of the resin falls within these ranges.

Acid value of the copolymer resin falls in the range of 2 to 60 mg KOH/g. By setting an acid value of a resin within this range, the resin emulsion and a water-based intermediate coating composition using the same improves various stabilities such as storage stability, mechanical stability, and stability against freezing. Also curing reaction with the curing agent such as melamine resin sufficiently proceeds during formation of coating film, so that various strengths, chipping resistance, and water resistance of the coating film are improved. If the acid value of the resin is less than 2 mg KOH/g, the above various stabilities are poor, and the curing reaction with the curing agent such as melamine resin does not sufficiently proceed so that the various strengths, chipping resistance, water resistance of the coating film are impaired. On the other hand, if the acid value of the resin is more than 60 mg KOH/g, polymerization stability of the resin may be deteriorated, the above stabilities and water resistance of the resultant coating film may be impaired. Therefore, the acid value of the resin is in the range of 2 to 60 mg KOH/g and preferably in the range of 5 to 50 mg KOH/g. The kinds and blending amounts of the above monomer components are selected so that the acid value of the resin falls within these ranges. As already described, it is important to use carboxylic acid group-containing monomers in the acid group-containing polymerizable unsaturated monomer (b), and carboxylic acid group-containing monomers occupy preferably not less than 50% by weight, more preferably not less than 80% by weight in the monomer (b).

Hydroxyl value of the copolymer resin falls within the range of 10 to 120 mg KOH/g. By setting a hydroxyl value of a resin within this range, the resin has appropriate hydrophilicity, and operability and stability against freezing increase when used as a coating composition including the resin emulsion. Also sufficient curing reactivity with melamine resin or isocyanate-type curing agent is realized. If the hydroxyl value is less than 10 mg KOH/g, the curing reaction with the curing agent is insufficient so that the coating material has poor mechanical properties, lacks in chipping resistance, and is inferior in water resistance and solvent resistance. On the other hand, if the hydroxyl value is more than 120 mg KOH/g, the water resistance of the resultant coating film may be decreased, or compatibility with the above curing agent is poor, so that distortion occurs in the coating film to cause nonuniform curing reaction. As a result of this, various strengths, in particular, chipping resistance, solvent resistance and water resistance of the coating film are deteriorated. Accordingly, the hydroxyl value of the resin is in the range of 10 to 120 mg KOH/g, and preferably in the range of 20 to 100 mg KOH/g. The kinds and blending amounts of the above monomer components are selected so that the hydroxyl value of the resin falls within these ranges.

The cross-linkable monomer (d) may be used in an amount ranging from 0.5% to 10% by weight, preferably from 1% to 8% by weight, relative to the total amount of the monomers (a), (b), and (c). Although depending on the kind of the monomer, by using the amount within this range, it is possible to obtain the cross-linking structure of the copolymer resin and achieve the effect of improving mechanical properties, in particular, chipping resistance, solvent resistance, and water resistance of the coating film. If the use amount of the cross-linkable monomer (d) is less than 0.5% by weight, the cross-linking structure of the coating film is not sufficiently formed, so that it is difficult to achieve the effect of improving chipping resistance, solvent resistance, and water resistance of the coating film. Whereas if the use amount of the cross-linkable monomer (d) is more than 10% by weight, adverse consequence such as gelation occurs in the manufacturing process of the resin, or even if no problem occurs in manufacturing process of the resin, undesired consequence such as unevenly formed coating film may occur.

Emulsion copolymerization may be performed by heating under stirring, the above monomer components in an aqueous solution in the presence of a radical polymerization initiator and an emulsifier. The reaction temperature is, for example, about 30 to 100° C., and the reaction time is preferably about 1 to 10 hours, for example. The reaction temperature may be adjusted by adding at once or dropping for a short time a monomer mixture or monomer pre-emulsion to a reaction vessel charged with water and emulsifier.

As the radical polymerization initiator, those which are commonly used in the emulsion polymerization of an acrylic resin may be used. Specifically, for a water-soluble free radical polymerization initiator, a persulfate such as potassium persulfate, sodium persulfate or ammonium persulfate may be used in the form of an aqueous solution. Also, combination with oxidizing agent such as potassium persulfate, sodium persulfate or ammonium persulfate or hydrogen peroxide and a reducing agent such as sodium hydrogensulfite, sodium thiosulfate, Rongalit or ascorbic acid, which is referred to as a redox initiator, may be used in the form of an aqueous solution.

As emulsifier, an anionic or non-ionic emulsifier which is selected from micelle compounds having a hydrocarbon group having not less than 6 carbon atoms and a hydrophilic part such as carboxylate, sulfonate or sulfate partial ester in its molecule may be used. Among such compounds, examples of the anionic emulsifier may include an alkaline metal salt or ammonium salt of a halfester of sulfuric acid with alkylphenols or higher alcohols; an alkaline metal salt or ammonium salt of an alkyl- or allyl-sulfonate; an alkaline metal salt or ammonium salt of a halfester of sulfuric acid with a polyoxyethylene alkylphenyl ether, polyoxyethylene alkyl ether or polyoxyethylene allyl ether and the like. Examples of the non-ionic emulsifier may include polyoxyethylene alkyl phenyl ether, polyoxyethylene alkyl ether or polyoxyethylene allyl ether and the like. In addition to these ordinary and commonly used anionic and non-ionic emulsifier, any of various anionic or non-ionic reactive emulsifier having in its molecule a radically polymerizable unsaturated double bond, i.e., having an acryl-, methacryl-, propenyl-, allyl-, allyl ether-, maleate-type groups may be used alone or in combination with each other.

In emulsion copolymerization, it is often preferred to use an auxiliary (chain transfer agent) for adjusting molecular weight, such as mercaptan-based compounds and lower alcohols from the view point of promoting the emulsion copolymerization and the view point of promoting smooth and uniform formation of the coating film, thereby improving the adhesion to the base material, and such an auxiliary is used as appropriate.

As emulsion copolymerization, any polymerization methods may be used including core-shell polymerization method implemented by a usual one-step continuous monomer uniform dropping technique and multi-step monomer feeding technique, or power feed polymerization method in which monomer composition to be fed is continuously changed during polymerization.

In this manner, the copolymer resin emulsion used in the present invention is prepared. Weight-average molecular weight of the resultant copolymer resin is not particularly restricted, however it is generally about 50,000 to 1,000,000, for example, about 100,000 to 800,000.

Furthermore, in the present invention, a basic compound is added to the resultant copolymer resin emulsion in order to neutralize a part or whole of the carboxylic acid to keep stability of the copolymer resin emulsion. As the basic compound, usually ammonia, various amines, alkaline metals, and the like are used, and these may be used in the present invention as appropriate.

In the present invention, the above-mentioned copolymer resin emulsion is further added with a curing agent to produce a water-based intermediate coating composition. Any curing agents may be used without particular restriction insofar as they can cause curing reaction with the copolymer resin and can be blended into the water-based intermediate coating composition. Examples of the curing agent include melamine resins, isocyanate resins, oxazoline-type compounds, carbodiimide-type compounds, and the like. These may be used alone or in combination of two or more.

As the melamine resins, those usually used as a curing agent may be used without particular restriction. For example, melamine resins that are alkyl etherified are preferred, and melamine resins that are substituted by a methoxy group and/or butoxy group are more preferred. As the above methoxy- and/or butoxy-substituted melamine resins, there maybe mentioned those having methoxy groups alone, such as Cymel 325, Cymel 327, Cymel 370 and Mycoat 723; those having both methoxy and butoxy groups, such as Cymel 202, Cymel 204, Cymel 232, Cymel 235, Cymel 236, Cymel 238, Cymel 254, Cymel 266 and Cymel 267 (all trade names, products of Mitsui Cytec Ltd.); and those having butoxy groups alone, such as Mycoat 506 (trade name, product of Mitsui Cytec Ltd.), U-Van 20N60 and U-Van 20SE (both trade names, products of Mitsui Chemical Co., Ltd.). These may be used alone or two or more of these may be used in combination. Among these Cymel 325, Cymel 327 and Mycoat 723 are more preferred.

The isocyanate resins are obtained from diisocyanate compounds by blocking with a suitable blocking agent. The above diisocyanate compounds are not particularly restricted insofar as they have at least two isocyanate groups in the molecule. Examples of the diisocyanate compounds include aliphatic diisocyanates such as hexamethylene diisocyanate (HMDI) and trimethylhexamethylene diisocyanate (TMDI); alicyclic diisocyanates such as isophoronediisocyanate (IPDI); aromatic-aliphatic diisocyanates such as xylylene diisocyanate (XDI); aromatic diisocyanates such as tolylene diisocyanate (TDI) and 4,4-diphenylmethanediisocyanate (MDI); hydrogenated diisocyanates such as dimer acid diisocyanate (DDI), hydrogenated TDI (HTDI), hydrogenated XDI (H6XDI) and hydrogenated MDI (H12MDI); and adducts or nurates of these isocyanates. These may be used alone or two or more of these may be used in combination.

The blocking agent for blocking diisocyanate compounds is not particularly restricted, and examples of such agents include oximes such as methylethyl ketoxime, acetoxime, and cyclohexanone oxime; phenols such as m-cresol and xylenol: alcohols such as butanol, 2-ethylhexanol, cyclohexanol, and ethylene glycol monoethyl ether; lactams such as ε-caprolactam; diketones such as diethyl malonate and acetoacetate esters; mercaptans such as thiophenol; ureas such as thiourea; imidazoles; carbamic acids, and the like. Among these, oximes, phenols, alcohols, lactams, and diketones are preferred.

The oxazoline-type compounds preferably have two or more 2-oxazoline groups, and examples of such compounds include the following oxzaolines and oxazoline group-containing polymers. These may be used alone or two or more kinds of these may be used in combination. Oxazoline-type compounds may be produced in the following manners: dehydration-cyclization of amide alcohol by heating in the presence of a catalyst, synthesis from alkanol amine and nitrile, or synthesis from alkanol amine and carboxylic acid.

Examples of the oxazolines include 2,2′-bis-(2-oxazoline), 2,2′-methylene-bis-(2-oxazoline), 2,2′-ethylene-bis-(2-oxazoline), 2,2′-trimethylene-bis-(2-oxazoline), 2,2′-tetramethylene-bis-(2-oxazoline), 2,2′-hexamethylene-bis-(2-oxazoline), 2,2′-octamethylene-bis-(2-oxazoline), 2,2′-ethylene-bis-(4,4′-dimethyl-2-oxazoline), 2,2′-p-phenylene-bis-(2-oxazoline), 2,2′-m-phenylene-bis-(2-oxazoline), 2,2′-m-phenylene-bis-(4,4′-dimethyl-2-oxazoline), bis-(2-oxazolinylcyclohexane)sulfide, bis-(2-oxazolinylnorbornane)sulfide and the like. These may be used alone or two or more of these may be used in combination.

The oxazoline group-containing polymer is obtained by polymerizing an addition-polymerizable oxazoline and, as necessary, at least one kind of other polymerizable monomer. Examples of the addition-polymerizable oxazolines include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-ethyl-2-oxazoline, and the like. These may be used alone or two or more of these may be used in combination. Among these, 2-isopropenyl-2-oxazoline is preferable because it is industrially accessible.

The use amount of the addition-polymerizable oxazoline is preferably, but not particularly restricted to, not less than 1% by weight in the oxazoline group-containing polymer. If the use amount is less than 1% by weight, the degree of curing is liable to be insufficient, so that durability, water resistance, and the like may tend to be impaired.

As the other polymerizable monomers, any monomers may be used without particular restriction insofar as they are able to copolymerize with the addition-polymerizable oxazoline and will not react with an oxazoline group, and examples of such monomers include (meth)acrylic acid esters such as methyl(meth)acrylate, butyl(meth)acrylate and 2-ethylhexyl(meth)acrylate; unsaturated nitriles such as (meth)acrylonitrile; unsaturated amides such as (meth)acrylamide and N-methyrol(meth)acrylamide; vinyl esters such as vinyl acetate and vinyl propionate; vinyl ethers such as methylvinyl ether and ethylvinyl ether; α-olefines such as ethylene and propylene; halogenated α,β-unsaturated monomers such as vinyl chloride, vinylidene chloride, and vinyl fluoride; α,β-unsaturated aromatic monomers such as styrene and α-methylstyrene and the like. These may be used alone or two or more of these may be used in combination.

The oxazoline group-containing polymer may be produced by polymerizing addition-polymerizable oxazoline with at least one kind of other polymerizable monomer as necessary by well-known polymerizing methods such as suspension polymerization, solution polymerization, emulsion polymerization and the like. The oxazoline group-containing compound may be supplied in the form of, but not particularly limited to, solution in organic solvent, aqueous solution, nonaqueous dispersion, emulsion and the like.

As the carbodiimide compound, the product of any of various methods may be used. Fundamentally, an isocyanate-terminated polycarbodiimide synthesized by the condensation reaction, accompanying carbon dioxide elimination, of an organic diisocyanate can be exemplified. More specifically, preferred examples include carbodiimide compounds modified for hydrophilicity which are obtainable in the process of manufacturing polycarbodiimide compounds by the step of reacting a polycarbodiimide compound having at least two isocyanate groups in the molecule with a hydroxy-terminated polyol in a mole ratio such that the number of moles of the isocyanate groups of the polycarbodiimide compound is in excess of the number of moles of the hydroxyl groups of the polyol and the step of reacting the reaction product obtainable in the preceding step with a modifier for hydrophilicity having an active hydrogen atom and a hydrophilic moiety.

The carbodiimide compound having at least two isocyanate groups in the molecule is not particularly restricted, but from the reactivity viewpoint, it is preferably a carbodiimide compound having an isocyanate group at both of the terminals. The method of producing carbodiimide compounds having an isocyanate group at both of the terminals is well known in the art, and for example, the condensation reaction of an organic diisocyanate under elimination of carbon dioxide may be utilized.

The use amount of the above-mentioned curing agent is 2% by weight to 50% by weight, preferably 4% by weight to 40% by weight, more preferably 5% by weight to 30% by weight, relative to the total amount of solid content of the curing agent and the copolymer resin emulsion. If the use amount is less than 2% by weight, water resistance of the resultant coating film is liable to decrease. Whereas if the amount is larger than 50% by weight, chipping resistance of the resultant film is liable to deteriorate.

The water-based intermediate coating composition of the present invention may further include the following components. For example, resin components other than the above copolymer resin, pigment-dispersed paste with dispersant, thickeners, and other additive components may be contained. These components may be added before or after adding the curing agent to the copolymer resin emulsion.

The above resin components other than the copolymer resin are not particularly restricted, and examples of such components include polyester resins, acrylic resins, urethane resins, carbonate resins, epoxy resins and the like. Preferably, these resin components are blended in a ratio of less than 50% by weight, relative to the solid content of all resins contained in the water-based intermediate coating composition. Blending them in an amount of larger than 50% by weight is not desired because it becomes difficult to increase the solid concentration of the coating material.

The pigment-dispersed paste with dispersant is obtained in advance by dispersing a pigment with a pigment dispersant. The pigment dispersant contains no or not more than 3% by weight of volatile basic substances, relative to the solid content of the pigment dispersant. In the water-based intermediate composition of the present invention, by using such a pigment dispersant, a coating film formed by the water-based intermediate coating material contains less volatile basic substance, so that it is possible to reduce the yellowing of the resultant multilayer coating film. Therefore, a pigment dispersant containing more than 3% by weight of volatile basic substance relative to the solid content of the pigment dispersant is not desired because the resultant multilayer coating film will be yellowed and finish appearance is liable to deteriorate.

The volatile basic substance refers to a basic substance having a boiling point of not more than 300° C., and inorganic and organic nitrogen-containing basic substances may be exemplified. As the inorganic basic substance, ammonia and the like may be exemplified. As the organic basic substances, amines may be exemplified, the amines including: primary to tertiary amines containing a straight or branched-chain alkyl group having 1 to 20 carbon atoms such as methylamine, dimethylamine, trimethylamine, ethylamine, diethylamine, triethylamine, isopropylamine, diisopropylamine, and dimethyldodecylamine; primary to tertiary amines containing a straight or branched-chain hydroxyalkyl group having 1 to 20 carbon atoms such as monoethanolamine, diethanolamine, and 2-amino-2-methylpropanol; primary to tertiary amines containing a straight or branched-chain alkyl group having 1 to 20 carbon atoms and a straight or branched hydroxyalkyl group having 1 to 20 carbon atoms such as dimethylethanolamine and diethylethanolamine; substituted or unsubstituted chain polyamines having 1 to 20 carbon atoms such as diethylenetriamine and triethylenetetramine; substituted or unsubstituted cyclic monoamines having 1 to 20 carbon atoms such as morpholine, N-methylmorpholine, and N-ethylmorpholine; substituted or unsubstituted cyclic polyamines having 1 to 20 carbon atoms such as piperazine, N-methylpiperazine, N-ethylpiperazine, and N,N-dimethylpiperazine and the like.

In the water-based intermediate coating composition of the present invention, a volatile basic substance may be contained in components other than the above-mentioned pigment dispersant. Therefore, it is preferred to reduce the weight of the volatile basic substance contained in the pigment dispersant as small as possible. That is, it is preferred to use a pigment dispersion which contains substantially no volatile basic substance for dispersion. Furthermore, it is more preferred not to use an amine-neutralization type pigment dispersion resin which is commonly used heretofore. It is also preferred to use the pigment dispersant so that the volatile basic substance is not more than 7×10⁻⁶ mmol per unit area of 1 mm² at the time of forming a multilayer coating film.

The pigment dispersant is a resin having a structure including a pigment affinity portion and a hydrophilic portion. As the pigment affinity portion and the hydrophilic portion, nonionic, cationic, and anionic functional groups may be exemplified. The pigment dispersant may have two or more of the above functional groups in its molecule.

Examples of the nonionic functional group include hydroxyl group, amide group, polyoxyalkylene group, and the like. Examples of the cationic functional group include amino group, imino group, hydrazino group, and the like. Examples of the anionic functional group include carboxyl group, sulfonic acid group, phosphoric acid group, and the like. Such pigment dispersant may be produced by a method well-known by skilled persons in the art.

The pigment dispersant is not particularly restricted insofar as it contains no or not more than 3% by weight of a volatile basic substance relative to the solid content of the pigment dispersant, but it is desired to use a pigment dispersant that is able to efficiently disperse the pigment in a small amount of the pigment dispersant. For example, commercially available dispersants may be used (the followings are trade names), concretely, Disperbyk 190, Disperbyk 181, Disperbyk 182 (macromolecular copolymer) and Disperbyk 184 (macromolecular copolymer) which are anionic/nonionic dispersants manufactured by BYK Chemie GmbH, EFKAPOLYMER 4550 which is anionic/nonionic dispersant manufactured by EFKA Corporation, Solsperse 27000 which is a nonionic dispersant, Solsperse 41000, Solsperse 53095 which are anionic dispersants manufactured by Avecia Limited and the like.

The number-average molecular weight of the pigment dispersant is preferably in the range of 1,000 to 100,000. If the number-average molecular weight is less than 1,000, dispersion stability may be insufficient, whereas if the number-average molecular weight is more than 100,000, the viscosity may be too high to make the handling difficult. The number-average molecular weight of the pigment dispersant is more preferably in the range of 2,000 to 50,000, and most preferably in the range of 4,000 to 50,000.

The pigment-dispersed paste with dispersant is obtained by mixing and dispersing the pigment dispersant and the pigment in accordance with a known method.

Any pigments that are commonly used in water-based coating materials may be used as the pigment without particular restriction, however, from the view point of improving the weathering resistance and securing the covering ability, it is preferable to use coloring pigments. In particular, titanium dioxide is more preferred because it is superior in coloring and covering ability and inexpensive.

Examples of the pigment beside titanium dioxide include organic coloring pigments such as azo chelate-type pigment, insoluble azo-type pigment, condensed azo-type pigment, phthalocyanine-type pigment, indigo pigment, perynone-type pigment, perylene-type pigment, dioxane-type pigment, quinacridone-type pigment, isoindolinone-type pigment, diketopyrrolopyrrole-type pigment, benzimidazolon-type pigment, and metal complex pigment; inorganic coloring pigments such as chrome yellow, yellow iron oxide, red iron oxide, carbon black. Those pigments may be used in combination with extender pigments such as calcium carbonate, barium sulfate, clay and talc.

In addition, as the pigment, standard gray coating materials containing as the main pigments carbon black and titanium dioxide may be used. Besides these, coating materials of which lightness or hue is adapted to that of the top coating material, as well as coating materials in which various kinds of coloring pigments are combined may be used.

Preferably, the weight ratio of the pigment relative to the total weight of the solid content of all the resins contained in the water-based intermediate coating composition and the pigment (PWC: pigment weight content) is in the range of 10% to 60% by weight. If the ratio is less than 10% by weight, the covering ability is liable to deteriorate. If the ratio is more than 60% by weight, viscosity increases at the time of curing, so that the flowability decreases and appearance of the coating film may deteriorate.

The content of the pigment dispersant is preferably in the range of 0.5% by weight to 10% by weight, relative to the weight of the pigment. If the content is less than 0.5% by weight, dispersion stability of the pigment may be poor because the blending amount of the pigment is too small. If the content is more than 10% by weight, the physical property of the coating film may be poor. Preferably the content falls within the range of 1% by weight to 5% by weight.

Examples of the thickener include, but not particularly limited to, cellulose-type thickeners such as viscose, methylcellulose, ethylcellulose, hydroxyethylcellulose and commercially available Tylose MH and Tylose H (trade names, products of Hoechst); alkaline thickening type thickeners such as sodium polyacrylate, polyvinylalcohol, carboxymethylcellulose, and commercially available Primal ASE-60, Primal TT-615, Primal RM-5 (products of Rohm&Haas), Ucar Polyphobe (products of Union Carbide); association type thickeners such as polyvinylalchol, polyethylene oxide, commercially available Adecanol UH-420, Adecanol UH-462, Adecanol UH-472, Adecanol UH-540, Adecanol UH-814N (products of Asahi Denka Co., Ltd.), Primal RH-1020 (products of Rohm&Haas), KURARAY POVAL (product of Kuraray Co., Ltd.) and the like. These may be used alone or in combination of two or more.

By containing the thickener, it is possible to increase the viscosity of the water-based intermediate coating composition, and hence it is possible to prevent occurrence of sags at the time of applying the water-based intermediate coating composition. In addition, it is possible to further suppress mixing of layers between the intermediate coating film and the base coating film. As a result of this, it is possible to improve the coating operability at the time of coating and provide excellent finish appearance of the resultant coating film in comparison to the case where a thickener is not contained.

The content of the thickener is preferably in the range of 0.01 parts by weight to 20 parts by weight, more preferably in the range of 0.1 parts by weight to 10 parts by weight, relative to 100 parts by weight of the resin solid content of the above water-based intermediate coating composition (solid content of all resins contained in the water-based intermediate coating composition). If the content is less than 0.01 parts by weight, thickening effect is not obtained, so that sags may occur at the time of coating, whereas if the content is more than 20 parts by weight, appearance and various performances of the resultant coating film may be deteriorated.

As other additives, additives that are usually added in addition to the above components, for example, UV absorbers, antioxidants, antifoaming agents, surface conditioners, pin-hole preventive agents and the like may be exemplified. The amounts of blending these agents are well-known by skilled persons in the art.

The production method of the water-based intermediate coating composition of the present invention is not particularly restricted, and any methods well-known by skilled persons in the art may be used. Further, the water-based intermediate coating composition of the present invention may be in any forms, for example, water-soluble, water-dispersed, aqueous emulsion and the like forms insofar as it is water-based.

Next, a method for forming a multilayer coating film of the present invention will be explained.

The method for forming a multilayer coating film of the present invention includes the following steps: (1) coating an object to be coated with an electrodeposition coating material to form an electrodeposition coating film; (2) applying the above-mentioned water-based intermediate coating composition on the electrodeposition coating film to form an intermediate coating film; and (3) applying a top coating material on the intermediate coating film by wet-on-wet coating technique to form a top coating film. Herein “wet-on-wet coating” refers to the process in which a plurality of coating films is applied on top of another without experiencing a curing process.

The coating method of each coating material is not particularly restricted, and for example, air electrostatic spraying generally called “REACT GUN”, and rotary-atomizing type electrostatic coating machine generally called “micro micro bell (μμ bell),” “micro bell (μ bell),” “metallic bell (metabell),” and soon may be practically used. It is preferred to conduct preheating after coating.

In the method for forming a multilayer coating film of the present invention, the intermediate coating film and the top coating film may be heated and cured simultaneously after conducting the above step (3).

In the above step (1), an object to be coated is coated with a cationic electrodeposition coating material. This cationic electrodeposition coating material is not particularly restricted, and any known cationic electrodeposition coating materials may be used. As such cationic electrodeposition coating material, coating compositions containing a cationic base resin and a curing agent may be exemplified.

Examples of the cationic base resin include, but are not particularly limited to, amine-modified epoxy resins as disclosed in Japanese Patent Publication No. Sho 54-4978, Japanese Patent Publication No. 56-34186 and the like; amine-modified polyurethane polyol resins as disclosed in Japanese Patent Publication No. Sho 55-115476 and the like; amine-modified polybutadiene resins as disclosed in Japanese Patent Publication No. Sho 62-61077, Japanese published unexamined application No. Sho 63-86766 and the like; amine-modified acrylic resins as disclosed in Japanese published unexamined application No. Sho 63-139909, Japanese Patent Publication No. Hei 1-60516 and the like; and sulfonium group containing resins as disclosed in Japanese published unexamined application No. Hei 6-128351 and the like. Also phosphonium-group containing resins may be used besides those disclosed in the above references. Among the above cationic base resins, it is particularly preferred to use amine-modified epoxy resins.

After coating with the cationic electrodeposition coating material, coating with the above-described water-based intermediate coating composition is conducted in the step (2). Coating of the water-based intermediate coating composition may be conducted in the coating method as described above. By carrying out drying or heating following the coating, an uncured dried intermediate coating film may be formed. The drying or heating operation is conducted for example, but not limited to, at a temperature ranging from room temperature to 100° C., for a period of time ranging from 30 sec. to 15 min.

The film thickness of the coating film after curing, formed of the water-based intermediate coating composition is not particularly restricted, but may be selected in accordance with the use thereof. The lower limit of the film thickness is preferably 10 μm, more preferably 15 μm. The upper limit of the film thickness is preferably 40 μm, more preferably 30 μm. If the film thickness exceeds these upper limits, disadvantages such as sags at the time of coating or pinhole associated with baking curing process may occur, whereas if the film thickness is below these lower limits, appearance of the resultant coating film and chipping resistance may be deteriorated.

In the step (3), the intermediate coating film obtained in the step (2) and not cured is coated with a top coating material.

Examples of the top coating material include, but not particularly limited to, those containing coating film formable resins, curing agents, pigments such as brightening pigments, coloring pigments and extender pigments, and various additives. As the coating film formable resins, for example, polyester resins, acrylic resins, urethane resins, carbonate resins, and epoxy resins may be used. From the view points of dispersibility of pigments and operability, combination of acrylic resin and/or polyester resin and melamine resin is preferred. As the curing agents, pigment and various additives, those used in the intermediate coating composition may be used.

The concentration of pigment contained in the top coating material (PWC) is generally in the range of 0.1% by weight to 50% by weight, preferably in the range of 0.5% by weight to 40% by weight, more preferably in the range of 1% by weight to 30% by weight. If the concentration of the pigment is less than 0.1% by weight, the pigment is not effective, whereas if the concentration of the pigment is more than 50% by weight, appearance of the resultant coating film may be deteriorated.

The top coating material may be prepared in the similar manner as described for preparation of the intermediate coating composition.

The form of the top coating material is not particularly restricted and may be in any forms of coating material, including, organic solvent type, water-based type (water-soluble, water-dispersed, emulsion) and nonaqueous dispersed forms. The top coating material is usually applied so that the film thickness after drying and curing of the coating film is in the range of 15 to 70 μm. If the film thickness after drying and curing is less than 15 μm, covering of the base may be insufficient or the film may become mottled, whereas if the thickness is more than 70 μm, sags at the time of application or pinhole at the time of heating and curing may occur.

The top coating material may be applied in the application method as described above. In the case where for example, an automobile body is coated with the top coating material, it is preferred to conduct the coating by a multistage, preferably two-stage coating method based on the above-mentioned air electrostatic spray coating or a coating method where the above-mentioned air electrostatic spray coating and the above-mentioned rotary-atomizing electrostatic coating are combined, in order to improve the ornamentalization. The resultant top coating film gives beautiful appearance and protection to the object to be coated.

The top coating film may be a multilayer including a base coating film formed of a organic solvent-based or water-based base coating material and a clear coating film. In such a case, in the above step (3), for example, after obtaining a base coating film by coating with the organic solvent-based or water-based base coating material, the base coating film is coated with a clear coating material to obtain an uncured clear coating film.

In the case where a base coating film is formed by using a water-based base coating material, it is possible to significantly reduce the organic solvents discharged in the coating process. Hence, employing such measure is more desired for realizing an environment-compatible coating process.

Examples of the base coating material include, but not particularly limited to, those containing coating film formable resins, curing agents, brightening agents, and other additives. Examples of the coating film formable resins include, but not particularly limited to, polyester resins, acrylic resins, urethane resins, carbonate resins, epoxy resins, and the like.

The base coating material is usually applied so that the film thickness after drying and curing of the coating film is in the range of 10 to 30 μm. If the film thickness after drying and curing is less than 10 μm, covering of the base may be insufficient or the film may become mottled, whereas if the thickness is more than 30 μm, sags at the time of application or pinhole at the time of heating and curing may occur. The base coating material can be applied in the application method as described above.

Examples of the clear coating material include, but not limited to, those containing coating film formable resins, curing agents, and other additives. Examples of the coating film formable resins include, but not limited to, acrylic resins, polyester resins, epoxy resins, urethane resins, and the like. These may be used in combination with curing agents such as amino resins and/or isocyanate resins. From the view points of transparency, acid etching resistance and the like, it is preferred to use the combination of acrylic resin and/or polyester resin and amino resin, or acrylic resin and/or polyester resin having carboxylic acid-epoxy curing system and the like.

The form of the clear coating material is not particularly limited and may be in any forms of coating material, including, organic solvent type, water-based type (water-soluble, water-dispersed, emulsion), nonaqueous dispersed type, and powder type. In addition, curing catalysts, surface conditioners and the like may be used as necessary.

The clear coating material may be prepared and applied in accordance with the conventional methods. The film thickness of the clear coating film after drying and curing is, for example, in the range of 10 to 70 μm though it varies depending on the use thereof. If the film thickness after drying and curing exceeds this upper limit, disadvantages such as decrease in sharpness or troubles such as unevenness and runs may occur at the time of coating, whereas if the film thickness is below the lower limit, appearance may be deteriorated.

The clear coating film obtained from the clear coating material is effective for smoothing unevenness of the base coating film resulting from a brightening agent when a metallic base coating material containing the brightening agent is used as the base coating material, thereby improving the gloss, or for protecting the base coating film.

For curing the resin by heating, the temperature is preferably in the range of 110° C. to 180° C., more preferably in the range of 120° C. to 160° C. By employing these ranges of temperature, it is possible to produce a cured coating film having a high degree of cross-linking. If the temperature is less than 110° C., the curing is liable to be insufficient, whereas if the temperature is more than 180° C., the resultant coating film may become hard and brittle. The heating time for curing is for example 10 to 60 min. when the temperature is in the range of 120 to 160° C. although it may be appropriately selected in accordance with the temperature being employed.

The object to be coated that may be coated according to the present invention is not particularly restricted insofar as it is a metallic product which can be subjected to cationic electrodeposition coating. Examples of such product include products made of iron, copper, aluminum, tin, zinc, and alloys containing these metals, as well as products that are plated or deposited with these metals.

### EXAMPLES

The following examples illustrate the invention in further detail. They are, however, by no means limitative of the scope of the invention. In these examples, “part (s)” means “part(s) by weight” unless otherwise defined.

### Example 1

### (A) Production of Water-Based Intermediate Coating Material

### (Preparation of Coloring Pigment Paste)

After premixing 9.4 parts of commercially available dispersant “Disperbyk 190” (trade name of a nonionic/anionic dispersant manufactured by Byk Chemie GmbH), 36.8 parts of ion-exchange water, 34.5 parts of rutile type titanium dioxide, 34.4 parts of barium sulfate, and 6 parts of talc, a glass bead medium was added in a paint conditioner, and mixed and dispersed until the grain size reached to 5 μm or less at room temperature, to obtain a coloring pigment-dispersed paste with dispersant.

### (Preparation of Resin Emulsion)

A reaction vessel which is commonly used for production of acrylic resin emulsion, equipped with a stirrer, thermometer, dropping funnel, reflux condenser, nitrogen introducing tube and the like, was charged with 445 parts of water and 5 parts of Newcol 293 (product of Nippon Nyukazai Co., Ltd.) and heated to 75° C. under stirring. A monomer mixture as defined below (the resin has acid value: 18, hydroxy value: 85 and Tg: −22° C.) and a mixture containing 240 parts of water and 30 parts of Newcol 293 (product of Nippon Nyukazai Co., Ltd.) were emulsified by using a homogenizer, and the resultant monomer pre-emulsion was dropped into the above reaction vessel over 3 hours under stirring. In parallel with dropping of the monomer pre-emulsion, a solution prepared by dissolving 1 part of APS (ammonium persulfate) in 50 parts of water was evenly dropped into the reaction vessel as a polymerization initiator until dropping of the monomer pre-emulsion completed. After completion of the dropping of the monomer pre-emulsion, the reaction was allowed to proceed for another 1 hour at 80° C. and then cooled. After cooling, a solution prepared by dissolving 2 parts of dimethylaminoethanol in 20 parts of water was added, to obtain a water-based resin emulsion containing 40.6% by weight of nonvolatile component.

### (Composition of Monomer Mixture)

| | |
|---|---|
| methyl methacrylate | 45 parts |
| butyl acrylate | 299 parts |
| styrene | 50 parts |
| 2-hydroxyethyl acrylate | 92 parts |
| methacrylic acid | 14 parts |
| ethyleneglycol dimethacrylate | 20 parts |

The obtained resin emulsion was adjusted to pH 7.2 by using 30% dimethylaminoethanol aqueous solution.

### (Preparation of Water-Based Intermediate Coating Material)

After mixing as a curing agent 20.9 parts of Cymel 327 (trade name; imino-type melamine resin, product of Mitsui Cytec Co., Ltd.) into 60.3 parts of the coloring pigment-dispersed paste with dispersant obtained in the above-mentioned manner and 109.7 parts of the resin emulsion obtained in the above-mentioned manner, 1.0 part of Adecanol UH-814N (trade name, urethane association type thickener, active ingredient 30%, product of Asahi Denka Co., Ltd.) was mixed and stirred, to obtain a water-based intermediate coating material.

### (B) Formation of Coating Film

A dull steel sheet treated with zinc phosphate was electrodeposited with Power Top U-50 (trade name, cationic electrodeposition coating material, product of Nippon Paint Co., Ltd.) so that the dried coating film had a thickness of 20 μm, heated at 160° C. for 30 min. for allowing the coating material to cure, followed by cooling, to prepare a steel sheet substrate.

The obtained substrate was coated with 20 μm coating by air spray coating with the above-mentioned intermediate coating material, subjected to preheating at 80° C. for 5 min., and then coated with 10 μm coating by air spray coating with AquaRex AR-2000 silver metallic (trade name, aqueous metallic base coating material, product of Nippon Paint Co., Ltd.) and subjected to preheating at 80° C. for 3 min. This coated substrate was then coated with Macflow O-1800W-2 clear (trade name, acid epoxy curable clear coating material, product of Nippon Paint Co., Ltd.) serving as a clear coating material by air spray coating so that the thickness of coating was 35 μm, and the subjected to curing by heating at 140° C. for 30 minutes, to thereby obtain a test piece.

The amount of basic substances remaining in the multilayer coating film before curing measured was 4.4 mmol. Further, the multilayer coating film obtained after heat curing had excellent appearance and was satisfactory in terms of yellowing because no yellowing change was observed.

The above water-based intermediate coating material, water-based base coating material, and clear coating material were diluted in the following conditions for use in coating.

Water-based intermediate coating material
Thinner: ion-exchange water
40 sec./No. 4 Ford cup/20° C.
Solid content of the coating material was 54% by weight.

Water-based base coating material
Thinner: ion-exchange water
45 sec./No. 4 Ford cup/20° C.

Clear coating material
Thinner: mixed solvent of EEP (ethoxyethylpropionate)/S-150 (trade name, aromatic hydrocarbon solvent, product of Exxon Corporation)=1/1 (w/w)
30 sec./No. 4 Ford cup/20° C.

### Examples 2 to 8

In Examples 2 to 8, water-based intermediate coating materials were prepared and test pieces of multilayer coating film were prepared in the same manner as described in Example 1 except that each resin emulsion was prepared in accordance with the monomer composition as listed in Table 1. In Examples 5 to 7, since 20 parts of diacetone acrylamide was used as a carbonyl group-containing monomer, each 10 parts of adipic dihydrazide was added after polymerization.

### Example 9

A water-based intermediate coating material was prepared and a test piece of multilayer coating film was prepared in the same manner as described in Example 1 except that 28.1 parts of Baydur LS-2186 (trade name, block type isocyanurate manufactured by Sumitomo Bayer Urethane, Ltd.) was used as a curing agent.

### Example 10

A water-based intermediate coating material was prepared and a test piece of multilayer coating film was prepared in the same manner as described in Example 1 except that 111.4 parts of resin emulsion and 5.5 parts of EPOCROS WS-500 (trade name, oxazoline group-containing compound manufactured by Nippon Shokubai Co., Ltd., water-soluble acryl copolymer, oxazoline equivalent 200 [solid/eq]) were used.

### Example 11

A water-based intermediate coating material was prepared and a test piece of multilayer coating film was prepared in the same manner as described in Example 1 except that 134.8 parts of resin emulsion and 21.9 parts of a modified carbodiimide compound dispersed in water as a curing agent that may be obtained in the following manner were used.

### (Preparation of Modified Carbodiimide Compound)

700 parts of 4,4-dicyclohexylmethanediisocyanate was allowed to react at 180° C. for 16 hours together with 14 parts of a catalyst for carbodiimidation (3-methyl-1-phenyl-2-phospholene-1-oxide), to obtain isocyanate-terminated 4,4-dicyclohexylmethanecarbodiimide (content of carbodiimide group: 4 equivalents). Then 226.8 parts of the obtained carbodiimide was dissolved in 106.7 parts of N-methylpyrrolidone under heating at 90° C., to obtain dissolved carbodiimide. Next, after stirring 200 parts of polypropyleneglycol (number-average molecular weight: 2,000) at 40° C. for 10 minutes, the dissolved carbodiimide and 0.16 parts of dibutyl tin dilaurate was added, heated to 90° C. again and allowed to react for 3 hours. To this reaction mixture, 96.4 parts of poly(oxyethylene)mono-2-ethylhexylether having 8 oxyethylene units was added, allowed to react for 5 hours at 100° C. and added with 678.1 parts of ion-exchange water at 50° C., to obtain a carbodiimide compound modified for hydrophilicity and having resin solid content of 40% in the form of dispersion in water.

### Comparative Examples 1 to 6

Water-based intermediate coating materials were prepared and respective test pieces of multilayer coating film were prepared in the same manner as described in Example 1 except that respective resin emulsions were prepared while changing the monomer composition as shown in Table 1. In Comparative examples 3, since 20 parts of diacetone acrylamide was used as a carbonyl group-containing monomer, 10 parts of adipic dihydrazide was added after polymerization.

TABLE 1

| | | | | | | | | | | | | resin | | |
|---|---|---|---|---|---|---|---|---|---|---|---|---|---|---|
| | monomer composition (parts by weight) | | | | | | | | | | | acid | hydroxyl | |
| | MMA | BA | ST | MAA | 2HEA | 4HBA | FM-1 | EGDMA | DVB | DAAAm | KBM-502 | value | value | Tg(° C.) |
| Example 1 | 45 | 299 | 50 | 14 | 92 | 0 | 0 | 20 | 0 | 0 | 0 | 18 | 85 | −22 |
| Example 2 | 83 | 231 | 62 | 14 | 0 | 110 | 0 | 20 | 0 | 0 | 0 | 18 | 82 | −25 |
| Example 3 | 52 | 291 | 53 | 14 | 0 | 0 | 90 | 20 | 0 | 0 | 0 | 18 | 40 | −21 |
| Example 4 | 83 | 231 | 62 | 14 | 0 | 110 | 0 | 0 | 20 | 0 | 0 | 18 | 82 | −25 |
| Example 5 | 83 | 231 | 62 | 14 | 0 | 110 | 0 | 0 | 0 | 20 | 0 | 18 | 82 | −25 |
| Example 6 | 62 | 291 | 53 | 14 | 0 | 0 | 90 | 0 | 0 | 0 | 10 | 18 | 40 | −21 |
| Example 7 | 72 | 231 | 62 | 25 | 0 | 110 | 0 | 0 | 0 | 20 | 0 | 31 | 82 | −24 |
| Example 8 | 82 | 291 | 62 | 25 | 0 | 50 | 0 | 0 | 0 | 0 | 10 | 31 | 37 | −20 |
| Example 9 | 45 | 299 | 50 | 14 | 92 | 0 | 0 | 20 | 0 | 0 | 0 | 18 | 85 | −22 |
| Example 10 | 45 | 299 | 50 | 14 | 92 | 0 | 0 | 20 | 0 | 0 | 0 | 18 | 85 | −22 |
| Example 11 | 45 | 299 | 50 | 14 | 92 | 0 | 0 | 20 | 0 | 0 | 0 | 18 | 85 | −22 |
| Comparative | 37 | 231 | 62 | 60 | 0 | 110 | 0 | 20 | 0 | 0 | 0 | 75 | 82 | −21 |
| example 1 | | | | | | | | | | | | | | |
| Comparative | 45 | 241 | 50 | 14 | 150 | 0 | 0 | 20 | 0 | 0 | 0 | 18 | 139 | −19 |
| example 2 | | | | | | | | | | | | | | |
| Comparative | 83 | 331 | 62 | 14 | 0 | 10 | 0 | 0 | 0 | 20 | 0 | 18 | 7 | −18 |
| example 3 | | | | | | | | | | | | | | |
| Comparative | 103 | 231 | 62 | 14 | 0 | 110 | 0 | 0 | 0 | 0 | 0 | 18 | 82 | −25 |
| example 4 | | | | | | | | | | | | | | |
| Comparative | 293 | 21 | 62 | 14 | 0 | 110 | 0 | 20 | 0 | 0 | 0 | 18 | 82 | 36 |
| example 5 | | | | | | | | | | | | | | |
| Comparative | 0 | 376 | 0 | 14 | 0 | 110 | 0 | 20 | 0 | 0 | 0 | 18 | 82 | −54 |
| example 6 | | | | | | | | | | | | | | |

* In each Example 5, 7 and Comparative example 3, 10 parts by weight of adipic dihydrazide was added after polymerization.

The abbreviations in Table 1 are as shown below.

### MMA: methyl methacrylate

### BA: butyl acrylate

### ST: stylene

### MAA: methacrylic acid

### 2HEA: 2-hydroxyethyl acrylate

### 2HBA: 2-hydroxybutyl acrylate

### FM-1: PLACCEL FM-1, manufactured by DAICEL INDUSTRIES, LTD.

### EGDMA: ethyleneglycol dimethacrylate

### DVB: divinylbenzene

### DAAm: diacetoneacrylamide

### KBM-502: alkoxysilyl group-containing monomer, manufactured by Shin-Etsu Chemical Co., Ltd.

In Table 1, values of acid value and hydroxyl value are obtained by calculation from blending amount of each polymerizable unsaturated monomer contained in the monomer mixture. “Tg” is obtained by rounding off a number which is calculated from glass transition temperature of homopolymer of each polymerizable unsaturated monomer contained in the monomer mixture and weight ratio of each monomer according to the above relational expression (I), to an integer.

### (C) Evaluation of Performances

Test pieces of multilayer coating film obtained by using the water-based intermediate coating materials produced in the above manners were evaluated for the following performances.

### 1. Appearance: Wave Scanning (SW Value)

The obtained test piece was evaluated for the finish appearance by measuring an SW value using “Wave scan” manufactured by Byk Chemie GmbH. The SW value is an index for evaluating principally luster and fine skin. The lower the SW value is, the better these properties are.

### 2. Chipping Resistance

The obtained test pieces were evaluated for chipping resistance in the following manner. Using a Gravel chipping test instrument (product of Suga Test Instruments Co., Ltd.), 300 pieces of No. 7 crushed stones were caused to collide with the coating film at an angle of 45° from a distance of 35 cm, at an air pressure of 3.0 kgf/cm². After washing with water and drying the test pieces, peeling test was conducted using an industrial gum tape manufactured by Nichiban Co., Ltd. and the degree of peeling of the coating film was evaluated by visual inspection.

### (Criteria for Judgment)

5: No peeling

4: Peeling with small area and low frequency

3: Peeling with small area and moderate frequency

2: Peeling with large area and low frequency

1: Peeling with large area and high frequency

### 3. Water Resistance

The obtained test pieces were immersed in warm water at 40° C. for 10 days and appearance following 1 hour washing was visually observed, and evaluated in accordance with the following criteria:

### (Criteria for Evaluating Appearance)

5: No change

4: Warm water boundary slightly swelled

3: Warm water boundary slightly darkened

2: Warm water boundary darkened

1: Warm water boundary swelled and coating film darkened

These results of performance evaluation are shown in Table 2.

TABLE 2

| | | wave | | |
|---|---|---|---|---|
| | | scanning | chipping | water |
| | curing agent | (SW value) | resistance | resistance |
| Example 1 | melamine | 9 | 5 | 5 |
| Example 2 | melamine | 11 | 4 | 5 |
| Example 3 | melamine | 10 | 4 | 5 |
| Example 4 | melamine | 8 | 5 | 5 |
| Example 5 | melamine | 10 | 4 | 5 |
| Example 6 | melamine | 9 | 5 | 5 |
| Example 7 | melamine | 8 | 5 | 5 |
| Example 8 | melamine | 11 | 4 | 5 |
| Example 9 | blocked isocyanate | 8 | 4 | 5 |
| Example 10 | oxazoline | 7 | 5 | 5 |
| Example 11 | carbodiimide | 10 | 5 | 5 |
| Comparative | melamine | 25 | 2 | 1 |
| example 1 | | | | |
| Comparative | melamine | 18 | 2 | 2 |
| example 2 | | | | |
| Comparative | melamine | 17 | 1 | 2 |
| example 3 | | | | |
| Comparative | melamine | 28 | 1 | 1 |
| example 4 | | | | |
| Comparative | melamine | 16 | 1 | 2 |
| example 5 | | | | |
| Comparative | melamine | 15 | 2 | 1 |
| example 6 | | | | |

From Table 2, any test pieces of multilayer coating film of Examples 1 to 8 had good appearance and exhibited excellent chipping resistance and water resistance. Also the test pieces of Examples 9 to 11 in which curing agents other than melamine resin were blended showed excellent coating film performance and exhibited excellent curability.

These results demonstrate that the water-based intermediate coating composition of the present invention enables coating to be conducted in high solid content condition, and has excellent coating efficiency. Furthermore, the water-based intermediate coating composition of the present invention will not cause settling, increase in viscosity and the like problems when stored for a long period time, and hence is excellent in storage stability.

1-9. (canceled)

10. A method for forming a multilayer coating film, comprising:
(1) coating an object to be coated with an electrodeposition coating material to form an electrodeposition coating film;
(2) applying a water-based intermediate coating composition on said electrodeposition coating film to form an intermediate coating film;
(3) applying a top coating material on said intermediate coating film without curing said intermediate coating material to form a top coating film; and
(4) curing said intermediate coating film and said top coating film simultaneously after said step (3),
wherein said water-based intermediate coating composition is a water-based intermediate coating composition comprising;
a copolymer resin emulsion, and
a curing agent,
the copolymer resin emulsion being emulsion-polymerized from:
a monomer (a) comprising at least one monomer selected from the group consisting of (meth)acrylic acid alkyl esters, and further comprising, as is necessary, at least one monomer selected from the group consisting of styrene-based monomers, (meth)acrylonitrile, and (meth)acrylamide;
an acid group-containing polymerizable unsaturated monomer (b);
a hydroxyl group-containing polymerizable unsaturated monomer (c); and
a cross-linkable monomer (d),
wherein a class transition temperature of said resin is in the range of −50° C. to 20° C., an acid value of said resin is in the range of 2 to 60 mg KOH/g, and a hydroxyl value of said resin is in the range of 10 to 120 mg KOH/g.

11. (canceled)

12. The method for forming a multilayer coating film according to claim 10, wherein said object to be coated is automobile body.

13. A multilayer coating film obtained by the method for forming a multilayer coating film according to claim 10.

14. The method for forming a multilayer coating film according to claim 10, wherein said cross-linkable monomer (d) comprises at least one cross-linkable monomer selected from the group consisting of carbonyl group-containing polymerizable unsaturated monomers, hydrolyzable polymerizable silyl group-containing monomers, and polyfunctional vinyl monomers.

15. The method for forming a multilayer coating film according to claim 10, wherein said water-based intermediate coating composition comprises at least said carbonyl group-containing polymerizable unsaturated monomers as said cross-linkable monomer (d) and a hydrazine compound as a cross-linking auxiliary agent.

16. The method for forming a multilayer coating film according to claim 10, wherein said curing agent comprises at least one curing agent selected from the group consisting of melamine resins, isocyanate resins, oxazoline-based compounds, and carbodiimide-based compounds.

17. The method for forming a multilayer coating film according to claim 10, wherein said cross-linkable monomer (d) is used in an amount of 0.5 to 10% by weight, relative to the total amount of said monomers (a), (b), and (c).

18. The method for forming a multilayer coating film according to claim 10, wherein said curing agent is contained in an amount of 2 to 50% by weight, relative to the total amount of solid content of said curing agent and said copolymer resin emulsion.

19. The method for forming a multilayer coating film according to claim 10, wherein said water-based intermediate coating composition further comprises a pigment-dispersed paste containing a pigment and a pigment dispersant.

20. The method for forming a multilayer coating film according to claim 19, wherein
said pigment is contained in an amount of 10 to 60% by weight, relative to the total amount of solid content of all resins contained in said water-based intermediate coating composition and said pigment, and
said pigment dispersant is contained in an amount of 0.5 to 10% by weight, relative to the amount of said pigment.

21. The method for forming a multilayer coating film according to claim 19, wherein said pigment dispersant contains no or not more than 3% by weight of volatile basic substances, relative to the solid content of said pigment dispersant.
